(19) United States
(12) Patent Application Publication
(10) Pub. No.: US 2007/0025604 A1
(43) Pub. Date: Feb. 1, 2007

(54) Method for creating a portable archive of personal medical information

(75) Inventors: Archie Lee Black, San Angelo, TX (US); James Lawrence Black, Centennial, CO (US)

Correspondence Address: Archie Lee Black, 3202 Tanglewood, San Angelo, TX, 76904, US

(73) Assignee: Advance Directives, Inc., San Angelo, TX (US)

(21) Appl. No.: 11/488,249

(22) Filed: Jul. 17, 2006

Related U.S. Application Data
(60) Provisional application No. 60/699,901, filed on Jul. 18, 2005.

(51) Int. Cl. G06K 9/00; G06F 19/00; G06F 17/00

(52) U.S. Cl. 382/128; 705/3; 707/104.1

(57) ABSTRACT

A sequence of steps to create a portable archive of medical information from hardcopy medical history documents and medical advanced directive documents onto a billfold-sized compact disc or similar electronic device so as to insure accuracy, security, and verifiability of personal information for use by medical practitioners is described.

### BACKGROUND OF THE INVENTION

1. Field Of the Invention

The current invention relates to collecting a person's medical information and then archiving that information on a portable digital device for convenient retention by the person and for display of the information to medical personnel in a manner that gives them confidence that the information is authentic, accurate, and complete.

2. Description of the Related Art

A patent search was executed in the area of (a) Medical information on Compact Disc and (b) Storage of Critical Medical Information. The following U.S. patent documents were the result of this search, none of which disclosed a method for creating an archive that a patient could carry conveniently on his/her person with the ability for the archive to convey to medical personnel that the information is accurate, complete, and identifiable as pertaining to Patient:
U.S. Pat. No. 6,970,826 Nov. 29, 2005 Christensen, et al.
U.S. Pat. No. 6,795,831 Sep. 21, 2004 Hirose, et al.
U.S. Pat. No. 6,314,089 Nov. 6, 2001 Szlam, et al.
U.S. Pat. No. 6,993,553 Jan. 31, 2006 Kaneko, et al
U.S. Pat. No. 6,286,682 Sep. 11, 2001 d'Arbelles
U.S. Pat. No. 6,994,781 Feb. 7, 2006 Cork, et al.
20,060,002,245 Jan. 5, 2006 Yamauchi; Yasuharu; et al
20,060,085,347 Apr. 20, 2006 Yiachos; George
20,060,149,973 Jul. 6, 2006 Koseki; Hitoshi; et al

The method described in this application for a creating a portable archive of a patient's medical information was developed over a period of years as it became more evident that quick, secure, and reliable access to such documents was required by medical personnel faced with medical situations in which Patient is unable give reliable information to medical personnel (e.g. because Patient is unconscious). Good medical treatment requires not only knowledge of Patient's medical history but also consent of Patient for medical personnel to take certain actions (such as performing an amputation, removing Patient from life-support systems, etc). Pertinent documents are advance medical directives (e.g. legal documents with directives such as “Do not put me on life support if my brain is dead.”) as well as information on a patient's medical history (e.g. past accidents, drug allergies, etc). The Texas legislature passed a law to insert on Texas Driver's licenses the fact that a Directive to Physicians could be retrieved by phoning a listed number printed on the back of Texas Driver's licenses. The procedure is not widely used by Texas citizens because the process takes too much time to deliver the documents to medical personnel. To address the issue of speed of document delivery, the next step was the creation of Internet website repositories (e.g. http://www.uslivingwillregistry.com) of such documents with access limited to hospitals and medical practitioners with assigned passwords. However, many patients balk at the idea of putting such personal information on website that could be broken into by hackers. Furthermore, hospital and medical practitioners are very sensitive to disclosure of medical information under the Health Insurance Portability and Accountability Act of 1996.

Recent events involving tragedy from the lack of advance directives and the involvement of the Federal government in these matters (e.g. the case of Terri Schiavo) has increased the importance of finding ways to have reliable personal Medical Documents available on short notice to medical personnel who are with a patient who needs urgent medical attention.

### BRIEF SUMMARY OF THE INVENTION

The invention is a method to create an archive of medical information that resides on a digital device that a patient carries on his/her person, for example in a wallet or purse with credit cards and driver's license. This portability solves the problem of overcoming delays for medical personnel to find and access the information. Furthermore Patient is more likely to archive private medical information in this manner than to put the information in a public arena such as the Internet. Finally the invention allows medical personnel to quickly gain confidence that the portable archive is accurate, complete, and applicable to Patient in question.

This method for creating a portable electronic archive containing personal medical information with a high degree of security and accuracy can, for example, be performed manually by a computer operator with a scanner, a computer with a writeable compact disc device, word-processing software, scanning software, disk-burning software, and a billfold-sized compact disc. Or it may be performed in more integrated fashion by a computer application that goes through essentially the same steps. The example manual process is as follows:

Turn on the scanner and computer

Insert a write-once compact disc in the appropriate computer drive, with the compact disc having been labeled with a Unique Identifier string of numerals and letters. (“Unique Identifier”)

Open a word processing application on the computer (e.g. Microsoft Office Word)

Scan each page to be included in the archive and add the digital image of each such page into a single document of the word-processing application (e.g. add each JPEG file to a single Microsoft Office Word document).

Configure the word processing application to number the pages in the document sequentially and to include the Unique Identifier as part of the footer on each page of the document.

Have Patient review each page in the word-processing document for readability and completeness.

Have Patient note that the Unique Identifier is at the bottom of each page and that the pages are numbered sequentially to include all the pages that Patient wants to archive.

Have Patient sign a Certificate that contains a government-issued photo id of Patient, the Unique Identifier, and a statement of how many pages are included in the archive.

Burn both the Certificate and the word-processor document to the billfold-sized write-once compact disc.

Remove all Patient's data from the computer.

Place billfold-sized CD in patient's wallet or purse to carry with him/her.

### BRIEF DESCRIPTION OF THE SEVERAL VIEWS OF THE DRAWING

FIG. 1 illustrates a flowchart of steps to carry out the method in its preferred implementation.

FIG. 2 illustrates an example of a Device 201 that has been labeled by the Unique Identifier 203.

FIG. 2A is an image of an actual Device 205 that has been labeled by the Unique Identifier 207. This is an image of a wallet-size write-once Compact Disc.

FIG. 3 illustrates the layout of the typical page 301 of in the Archive, showing the Representation 303 of Medical Document, the page numbering 309 and the Unique Identifier 307.

FIG. 4 illustrates Certificate 401 that brings together on one page the Unique Identifier 411, the image of the government-issued photo id 407, Patient's signature 409 and other Patient Identity Information 405.

### DETAILED DESCRIPTION OF THE INVENTION

Glossary of Terms. Each term below has a specialized use in describing the invention and is always capitalized when so used:

“Archive” refers to a computer file or files containing images, text, and other computer-readable data for storing and retrieving Medical Documents of Patient.

“Certificate” refers to a page that connects the Patient's identity and intentions with the other pages of the Archive. At a minimum, the Certificate contains the Patient's signature and the Unique Identifier. The Certificate may also contain additional material such as an image of a government-issued Photo ID belonging to the Patient, other Patient Identity Information such as address, date-of-birth, signature(s) of witnesses, and attestation to the number of pages in the Archive.

“Device” refers to a portable, write-once digital device that can store computer files so that they can be viewed on a computer different from the one on which they were created. Examples are write-once Compact Discs, write-once FLASH-memory devices, etc. The term “write-once” means that a computer can only write files to the Device in one continuous operation, defined by the period of time between which the write operation starts and the write operation terminates. Once the write operation terminates, no files may be added nor removed from the Device.

“Medical Document” refers to hardcopy or digital document containing all or part of a person's medical history, medical conditions, directives to medical personnel as to how to treat the person, and any other information that the Patient or Patient's advisors deem to be potentially useful to medical personnel in treating Patient.

“Representation” refers to a computer file in a digital format, representing one page of a document. An example would be a JPEG representation of a page that has been scanned into a computer. If the document is already in digital format, then its Representation can be itself.

“Patient” refers to the specific person for whom a portable archive of personal medical information is being created in this invention.

“Patient Identity Information” refers to information that serves to identify Patient, such as name, address, date of birth, Social-Security Number, . . .

“Unique Identifier” refers to a string of numerals and letters that serves to uniquely identify the connection between the Patient and the Archive. The uniqueness requirement is that each Patient for whom an Archive is created shall have a Unique Identifier that differs from those of all other people who have such Archives.

“Registration Website” refers to an Internet website that contains an association between the Unique Identifier and Patient Identity Information.

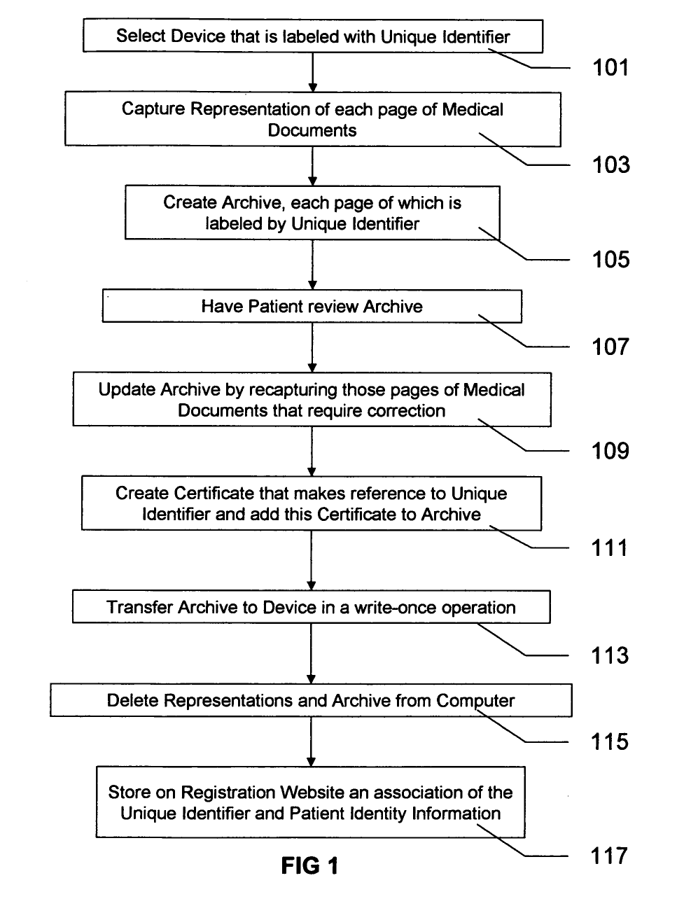

Referring now to drawings, FIG. 1 illustrates the sequence of steps to create the Archive for the person to whom the Medical Documents pertain (“Patient”).

The first step 101 is to select a Device that has been visibly and indelibly labeled with a Unique Identifier. The uniqueness of the Unique Identifier can be guaranteed by any number of existing computer algorithms for generating unique strings for a finite population of patients who could potentially request an Archive, including the technique of keeping a database of all registered patients and generating new Unique Identifier that differs from all previous ones.

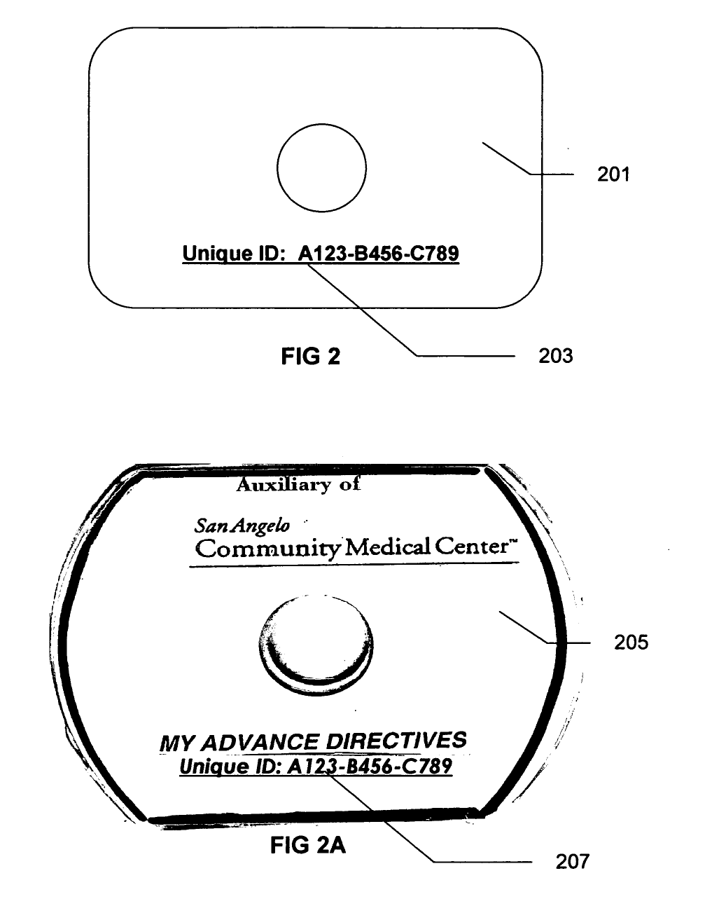

FIG. 2 and shows a schematic of such a Device 201 (and FIG. 2A shows an image of a specific example: a billfold-sized Compact Disc) with the Unique Identifier 203 labeling the Device. The labeling of Device 201 may be done by manually writing the Unique Identifier on the Device with an indelible marker, by printing the Unique Identifier on the Device in non-erasable ink, by embossing the Unique ID into a non-active part of the Device, or by other similar methods.

The next step 103 shown in FIG. 1 is to capture a digital image (“Representation”) of each page of Medical Documents that Patient submits to become part of the Archive. This step can be performed with any number of standard computer devices that turn documents into digital images, including scanners, copiers, and digital cameras. The Representation of each such page will now reside in the memory of the computer until the next step 105.

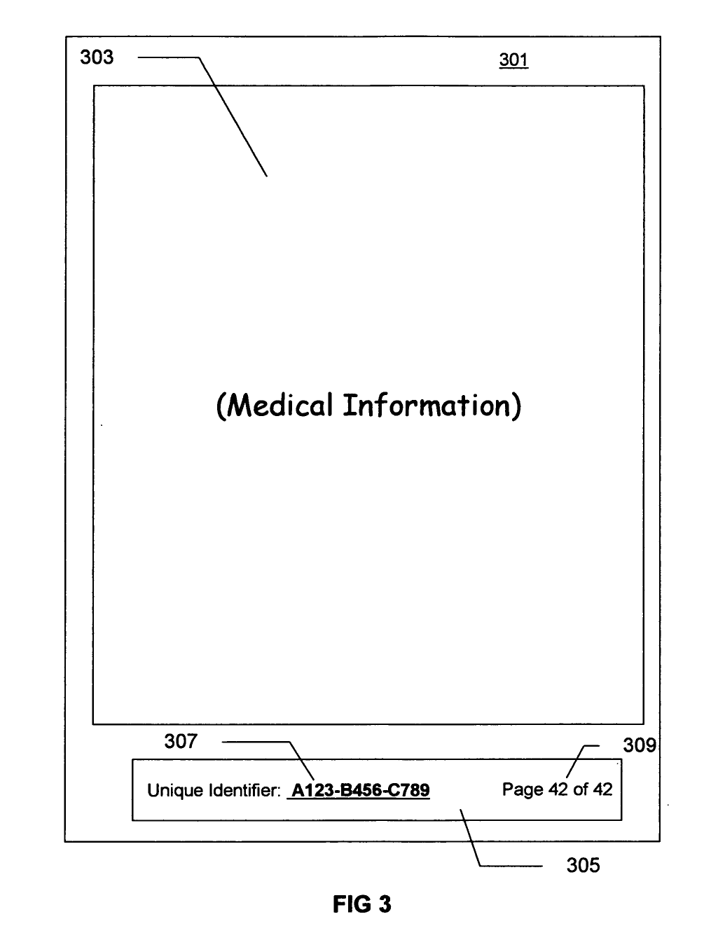

The next step 105 in FIG. 1 is to assemble all Representations of all submitted Medical Documents into file of digital documents (“Archive”) consisting of pages of information such as are shown in FIG. 3. Each such page 301 consists of the Representation 303 of a page of a Medical Mocument, augmented by additional information. In FIG. 3, for example, the Representation 303 is augmented by a footer 305 that contains the additional information of page sequence number 309 and the Unique Identifier 307.

These pages of the Archive may reside in computer memory but may also be stored on computer disk if it is too large to fit in computer memory.

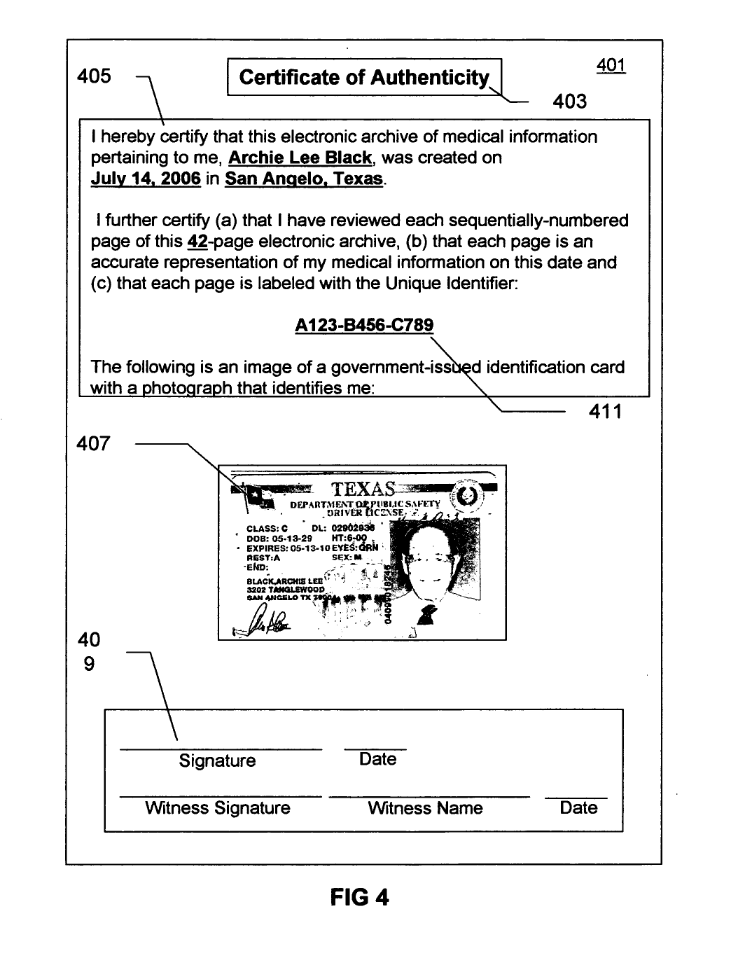

As part of step 105, label each page in the Archive with a sequential page number, shown as 309 in FIG. 4.

As part of step 105, label each page in the Archive with the Unique Identifier so that it appears on each page in the Archive, as is shown by 307 in FIG. 3.

FIG. 4 shows the important features of each page of the Archive, and us shown as the last page of the Archive as an example only. The footer area 305 of all other pages differs from this example only in the sequential page number 309 that appears. The Unique Identifier 307 is the same on each page of the Archive.

The next step 107 in FIG. 1 is for Patient and others to review the Archive for readability, completeness, and presence of Unique Identifier and page-sequence information. This may be done by having Patent view the Archive on a computer screen, look at printed output of the Archive on paper, or similar techniques well known to those practiced in the art.

If Patent or others find in Archive any illegible pages, missing pages, or pages that do not contain visible sequential page numbers or the Unique Identifier, the next step 109 is to remedy the shortcoming by recapturing the medical document and ensuring that the page number and Unique Identifier are present on the re-captured page.

The next step 111 in FIG. 1 is to create the Certificate 401 and print it for Patient to review and sign. FIG. 4 shows the components of the Certificate 401:

The Certificate 401, labeled by a title 403 indicating its purpose, must contain a Patient-statement area 405 that must contain patient-identification information and must contain a statement attesting to the validity of the Archive. Statement attesting to the validity of the Archive may refer to the number of pages in the Archive and to the presence of the Unique Identifier label on each page of the Archive.

The Certificate 401 may also contain an image of Patient's government-issued photo id 407.

The Certificate 401 must contain Patient's signature 409 and may contain a witness signature.

The Certificate 401 must contain a display of the Unique Identifier 411.

Once Patient has signed the Certificate 401 in step 111, continue step 111 by capturing the signed Certificate into a digital representation and adding this digital representation of the Certificate to the Archive.

The next step 113 in FIG. 1 is to transfer the Archive, now containing a representation of the Certificate 401, onto the Device 201. This constitutes the one and only write operation that can ever occur for this Device, since it is a write-only device. Thus, in the future, all who read from this device have high certainty that all the pages of the Archive, including the Certificate 401, were written to the Device 201 in the same write operation and that nothing has been added or deleted from the Device 201 since that write operation finished. Further certainty comes from the fact that the Unique Identifier 203 that is visibly displayed on the Device matches both the Unique Identifier 411 on the Certificate 401 and the Unique Identifier 307 that labels each page of the Archive.

The final part of Step 113 is to deliver the Device 201 to Patient (or to Patient's designated representative) so that Patient can carry Device 201 with him/her on his/her person. This Archive now consists of pages of medical information such as are shown in FIG. 3, plus the Certificate such as is shown in FIG. 4.

To protect the privacy of Patient, the next step 115 in FIG. 1 is to delete from the computer memory, disk and all other storage devices the Representation of each captured medical document and the entire Archive. At this point the only remaining electronic form of Patient's Medical Documents is the Archive contained on the Device 201, which is now in his/her possession.

An optional final step 117 in FIG. 1 is to register the existence of the Archive on the Device 201 on a Registration Website on the Internet, associate the Unique Identifier with Patient Identity Information such as Patient's name. The purpose of this optional step is to allow medical practitioners to have yet another way of confirming that the Device 201 pertains to Patient. Note that this does not involve storing any of Patient's medical information on the Internet.

What is claimed is:

1. A method for creating a portable archive of Patient's Medical Documents that medical personnel can display on a computer at a medical services facility, comprising the following steps carried out either manually or under the sequencing of a software application:
selecting a Device that is indelibly labeled with a Unique Identifier;
capturing a Representation of each page of Patient's chosen Medical Documents by means of a scanner, camera, copy machine or other such digital-imaging device;
creating a Archive in which each Representation is placed on a page labeled by the Unique Identifier;
reviewing said Archive on a computer screen or as hard copy;
recapturing said Medical Documents until Patient approves the Archive as complete, legible, and identifiable;
transferring approved Archive to Device in a write-once operation.

2. The method of claim 1 wherein the Archive and Representations are completely erased from the computer after Archive is transferred to Device.

3. The method of claim 1 wherein the page-sequence number in addition to the Unique Identifier serves as a label for each page in the Archive.

4. The method of claim 3 wherein the Archive and Representations are completely erased from the computer.

5. A method for creating a portable archive of Patient's Medical Documents that medical personnel can display on a computer at a medical services facility, comprising the following steps carried out either manually or under the sequencing of a software application:
selecting a Device that is indelibly labeled with a Unique Identifier;
capturing a Representation of each page of Patient's chosen Medical Documents by means of a scanner, camera, copy machine or other such digital-imaging device;
creating a Archive in which each Representation is placed on a page labeled by a page-sequence number and by the Unique Identifier;
reviewing said Archive on a computer screen or as hard copy;
recapturing said Medical Documents until Patient approves the Archive as complete, legible, and identifiable;
creating a Certificate that contains Patient Identity Information, the Unique Identifier, the number of pages, and Patient's signature.
adding Representation of Certificate to Archive;
transferring approved Archive to Device in a write-once operation.

6. The method of claim 5 wherein the Archive and Representations are completely erased from the computer after Archive is transferred to Device.

7. The method of claim 5 wherein an image of Patient's government-issued photo id is included in the Certificate.

8. The method of claim 7 wherein the Archive and Representations are completely erased from the computer after Archive is transferred to Device.

9. The method of claim 5 wherein the page-sequence number in addition to the Unique Identifier serves as a label for each page in the Archive.

10. The method of claim 9 wherein wherein the Archive and Representations are completely erased from the computer after Archive is transferred to Device.

11. The method of claim 9 wherein an image of Patient's government-issued photo id is included in the Certificate.

12. The method of claim 11 wherein the Archive and Representations are completely erased from the computer after Archive is transferred to Device.

13. The method of claim 5 wherein an association between Patient's identifying data and the Unique Identifier is posted on a Registration Website.

14. The method of claim 13 wherein an image of Patient's government-issued photo id is included in the Certificate.

15. The method of claim 14 wherein the page-sequence number in addition to the Unique Identifier serves as a label for each page in the Archive.

16. The method of claim 15 wherein the Archive and Representations are completely erased from the computer after Archive is transferred to Device.
